(19) United States
(12) Patent Application Publication
(10) Pub. No.: US 2015/0120679 A1
(43) Pub. Date: Apr. 30, 2015

(54) SYSTEM AND METHOD FOR IDENTIFYING AN INDIVIDUAL FROM ONE OR MORE IDENTITIES AND THEIR ASSOCIATED DATA

(71) Applicant: InfoTrellis Inc., Toronto (Ontario) (CA)

(72) Inventors: David Borean, Aurora (CA); Atif Khan, Waterloo (CA); Mohamed Riyaz Hameed, Tiruchirappalli (IN); Aniket Dutta, Nadia (IN)

(21) Appl. No.: 14/524,572

(22) Filed: Oct. 27, 2014

(30) Foreign Application Priority Data
Oct. 25, 2013 (IN) 4826/CHE/2013

(51) Int. Cl. G06F 17/30

(52) U.S. Cl. CPC G06F 17/30371
USPC 707/690

(57) ABSTRACT

The one or more non-transitory computer readable storage mediums storing one or more sequences of instructions are provided. The one or more non-transitory computer readable storage mediums executed by one or more processors causes (i) obtaining a associated data of an individual from one or more identities, (ii) extracting information from the associated data to obtain an extracted information, (iii) standardizing the extracted information to obtain a standardized extracted information, (iv) obtaining additional information associated with the one or more identities based on the standardized extracted information, (v) calculating a confidence level for the additional information, (vi) comparing, the additional information with trustworthy information from a database to verify an accuracy of the additional information, and (vii) identifying the individual from the one or more identities and the associated data based on the confidence level and the accuracy.

### CROSS-REFERENCE TO RELATED APPLICATIONS

This application claims priority to Indian patent application no.

4826/CHE/2013 filed on Oct. 25, 2013, the complete disclosure of which, in its entirely, is herein incorporated by reference.

### BACKGROUND

1. Technical Field

The embodiments herein generally relate to data management system and, more particularly, to a system and method for identifying an individual from one or more identities and their associated data.

2. Description of the Related Art

A major challenge over the past has been in trying to match data which is untrustworthy or sparsely populated, with internal entities. For example, Twitter® user data such as name, high level location information like city, state or province and, a set of tweets, etc. is sparsely populated and untrustworthy because there are no rules that enable determination of whether the information is real and valid or not. This is a challenge because historically customer records, product records and other entities are matched together using internal information that contains stronger identifying data. For example, date of birth, tax identifiers and granular address information are used for matching customer records together. The other challenges in the context of enterprises such as a retailers, financial services companies, telecommunication companies, etc is that social media data is external information and is therefore not trusted.

Traditional entity resolution engines have been available in the market for some time. But these entities take one or more approaches for matching entities such as customer records. These solutions are configured to work with demographic information as the records are internal and generally have a complete set of information. For example, they work with names, granular addresses, date of births, phone numbers, tax identifiers, etc. These engines and the approaches that are used are not sufficient for working with sparse data. They fail in matching as there are many false negative matches and duplicates are also missed. Accordingly, there remains a need for a better technique for matching heterogeneous entities with sparse data and unreliable information with the internal data.

### SUMMARY

In view of the foregoing, an embodiment herein provides a one or more non-transitory computer readable storage mediums storing one or more sequences of instructions. The computer readable storage mediums which when executed by one or more processors causes (i) obtaining a associated data of an individual from one or more identities, (ii) extracting information from the associated data to obtain an extracted information, (iii) standardizing the extracted information to obtain a standardized extracted information, (iv) obtaining additional information associated with the one or more identities based on the standardized extracted information, (v) calculating a confidence level for the additional information, (vi) comparing the additional information with trustworthy information from a database to verify an accuracy of the additional information, and (vii) identifying the individual from the one or more identities and the associated data based on the confidence level and the accuracy. The confidence level is derived based on at least one of (i) a quality, or (ii) an origin of the associated data.

The associated data may include at least one of (i) one or more posts on a social medium, (ii) data associated with an identity on a social medium, (iii) documents, (iv) emails, or (v) web logs. The standardized extracted information may be obtained by at least one of (a) removing one or more noise words from the extracted information, (b) standardizing case associated with the extracted information, or (c) standardizing references associated with the extracted information. The references associated with the information include (i) a city names, (ii) states/provinces, (iii) units of measures, (iv) one or more terms associated with a name. The associated data may include unstructured data. The extracted information may include at least one of (i) information associated with a name, (ii) information associated with a location, (iii) information associated with a relationship, (iv) other demographic information, or (v) interaction information. The one or more non-transitory computer readable storage mediums may further includes a weight is assigned for the additional information to derive the confidence level.

In one aspect, an entity matching server for identifying an individual from one or more identities and associated data is provided. The entity matching server include (i) a memory unit that stores (a) a set of modules, and (b) a database, and (ii) a processor which when configured by the instructions executes the set of modules. The set of modules include (a) an associated data obtaining module, executed by the processor, that obtains associated data associated with the individual from the one or more identities; (b) an information extracting module, executed by the processor, that extracts information from the associated data to obtain an extracted information; (c) an additional information obtaining module, executed by the processor, that obtains additional information associated with the one or more identities based on the extracted information; (d) a confidence level identifying module, executed by the processor, that calculates a confidence level for the additional information; (e) a comparison module, executed by the processor, that compares the additional information with trustworthy information from a database to verify an accuracy of the additional information; and (f) an individual identification module, executed by the processor, that identifies the individual from the one or more identities and the associated data based on the confidence level and the accuracy. The associated data include unstructured data. The database includes an associated data and extracted information. The extracted information includes at least one of (i) an information associated with a name, (ii) an information associated with a location, (iii) an information associated with a relationship, (iv) other demographic information, or (v) interaction information.

The associated data may include at least one of (i) one or more posts from a social medium, (ii) data associated with an identity on a social medium, (iii) documents, (iv) emails, or (v) web logs. The set of modules further include an extracted information standardizing module, executed by the processor that standardizes the extracted information to obtain standardized extracted information. The standardized extracted information is obtained by at least one of (i) removing one or more noise words from the information, (ii) standardizing case associated with the extracted information, or (iii) standardizing references associated with the extracted information. The references associated with the information include (i) city names, (ii) states/provinces, (iii) units of measures, and (iv) one or more terms associated with a name. The confidence level is derived based on at least one of (i) a quality, or (ii) an origin of the associated data. The set of modules may further include a weight assigning module, executed by the processor that assigns a weight for the additional information to derive the confidence level.

In another aspect, a processor implemented method of identifying an individual from one or more identities and associated data is provided, the processor implemented method include (i) obtaining the associated data associated with the individual from the one or more identities, (ii) extracting information from the associated data to obtain an extracted information, (iii) standardizing the extracted information by at least one of (a) removing one or more noise words from the extracted information, (b) standardizing case associated with the extracted information, or (c) standardizing references associated with the extracted information, (iv) obtaining additional information associated with the one or more identities based on the standardized extracted information, (v) calculating a confidence level for the additional information, (vi) comparing the additional information with trustworthy information from a database to verify an accuracy of the additional information, and (vii) identifying the individual from the one or more identities and the associated data based on the confidence level and the accuracy. The associated data include unstructured data. The extracted information include at least one of (i) information associated with a name, (ii) information associated with a location, (iii) information associated with a relationship, (iv) other demographic information, or (v) interaction information. The confidence level is derived based on (i) a quality, or (ii) an origin of the associated data.

The associated data may include at least one of (i) one or more posts on a social medium, (ii) data associated with an identity on a social medium, (iii) emails, or (iv) web logs. The references associated with the information may include (i) city names, (ii) states/provinces, (iii) units of measures, (iv) one or more terms associated with a name. The processor implemented method further include, a weight is assigned for the additional information to derive the confidence level.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a system view illustrating an entity matching server interacts with a computing device for identifying an individual from one or more identities and their associated data according to an embodiment herein;

FIG. 2 illustrates an exploded view of the entity matching server of FIG. 1 according to an embodiment herein;

FIG. 3 is a flow diagram illustrating a method of identifying an individual from one or more identities and their associated data according to an embodiment herein;

FIG. 4 illustrates an exploded view of the computing device used in according to an embodiment herein; and

FIG. 5 illustrates a schematic diagram of a computer architecture according to an embodiment herein;

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

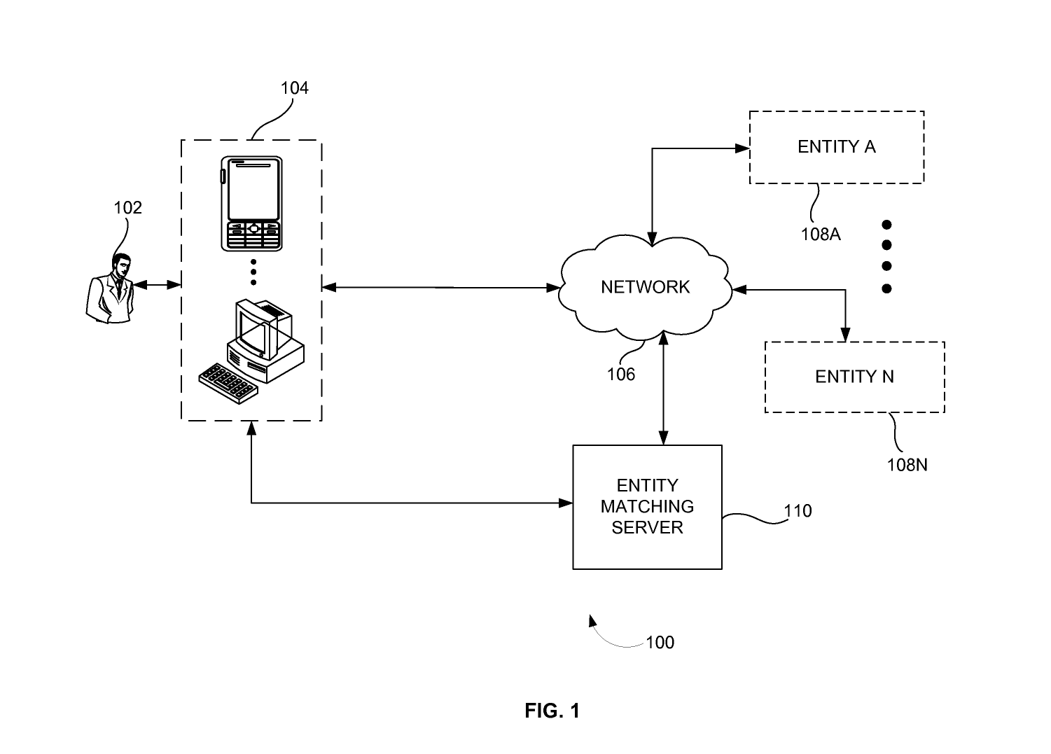

As mentioned, there remains a need for a better technique for matching heterogeneous entities with sparse data and unreliable information with the internal data. The embodiments herein achieve this by providing an entity matching server for identifying an individual from one or more entities and associated data. The associated data associated with an individual from the one or more entities (e.g., one or more identities). Unstructured data may be related to the individual, whose information is to be compared between one or more heterogeneous entities, or between the heterogeneous entities and an internal database. Then additional information associated with one or more identities is obtained. A confidence level is obtained for the additional information. Based on the confidence level, an individual is identified from one or more entities and associated data. Referring now to the drawings, and more particularly to FIGS. 1 through 5, where similar reference characters denote corresponding features consistently throughout the figures, preferred embodiments are shown.

FIG. 1 is a system view 100 illustrating an entity matching server 110 interacts with a computing device 104 for identifying an individual from one or more identities and their associated data according to an embodiment herein. The system view 100 includes a user 102, the computing device 104, a network 106, one or more identities 108A-N, and the entity matching server 110. The user 102 may request for an individual's data through the computing device 104. The computing device 104 associated with the user 102 may obtain unstructured data of the individual from one or more of the heterogeneous entities 108A-N through the network 106. In one embodiment, the computing device 104 is selected from a group includes a personal computer, a mobile communication device, a smart phone, a tablet PC, a laptop, a desktop, and an ultra-book. In one embodiment, the network 106 may be an internet.

The one or more identities 108A-N is one or more entities 108A-N. In another embodiment, the one or more identities 108A-N may be one or more heterogeneous entities. In one embodiment, the one or more entities are at least one of (i) external entities, and (ii) internal entities with sparse information. For example, the external entities are one or more social medium such as Facebook®, Twitter®, LinkedIn®, but not limited to other social networking sites. In another example, the internal entities include customer records in a master data management, hub or data warehouse, customer or prospect data within unstructured documents such as emails, scanned documents, call center logs.

The entity matching server 110 obtains associated data of an individual from one or more identities 108A-N. In one embodiment, the associated data may be unstructured data, or structured data. The unstructured data which may contain information on the individual. The information is extracted from the associated data to obtain extracted information. A standardization of unstructured data based on the extracted information is standardized obtained from the one or more identities 108A-N. Additional information associated with the one or more identities 108A-N is obtained based on the standardized extracted information. Then, a confidence level is calculated for the additional information. The confidence level is derived based on at least one of (i) a quality, or (ii) an origin of the associated data. The additional information with trustworthy information from a database is compared to verify an accuracy of the additional information. The individual is identified from the one or more identities and the associated data based on the confidence level.

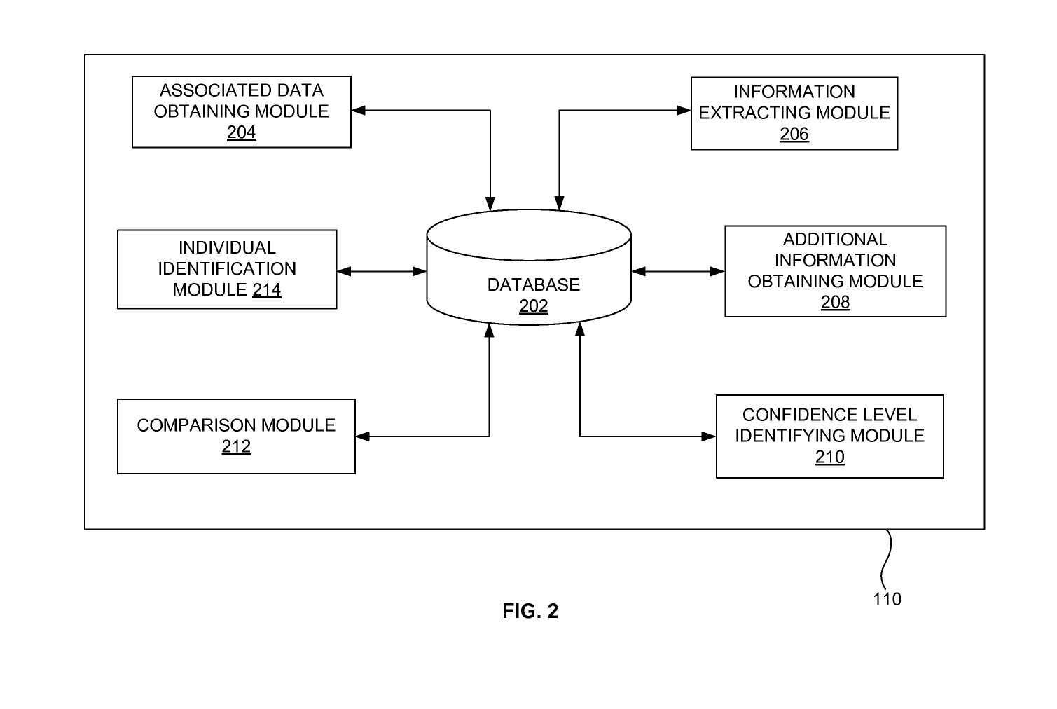

FIG. 2 illustrates an exploded view of the entity matching server 110 of FIG. 1 according to an embodiment herein. The entity matching server 110 includes a database 202, an associated data obtaining module 204, an information extracting module 206, an additional information obtaining module 208, an confidence level identifying module 210, an comparison module 212, an individual identification module 214. The entity matching server 110 include (i) a memory unit that stores (a) a set of modules, and (b) a database. The database 202 includes an associated data and extracted information. The extracted information includes at least one of (i) an information associated with a name, (ii) an information associated with a location, (iii) an information associated with a relationship, (iv) other demographic information, or (v) interaction information (e.g., a purchase reference, a purchase completion date, a purchase location). The associated data includes at least one of (i) one or more posts from a social medium, (ii) data associated with an identity on a social medium, (iii) documents, (iv) emails, or (v) web logs. The associated data obtaining module 204 obtains associated data associated with the individual from the one or more identities 108A-N. In one embodiment, the associated data includes one or more unstructured data. The information extracting module 206 extracts information from the associated data to obtain extracted information. The entity matching server 110 further includes an extracted information standardizing module that standardizes the extracted information to obtain standardized extracted information. In one embodiment, the standardized extracted information is obtained by at least one of (i) removing one or more noise words from the information, (ii) standardizing case, or (iii) standardizing references associated with the extracted information. In one embodiment, the references associated with the information include (i) city names, (ii) states/provinces, (iii) units of measures, and (iv) one or more terms associated with a name. For example, CM=Centimeter, name terms INC=Incorporated.

The additional information obtaining module 208 that obtains additional information associated with the one or more identities based on the extracted information. In one embodiment, the entity matching server 110 employs pre-processing of associated data using techniques and knowledge engineering techniques (e.g., a deterministic reasoning to derive information (i.e. determining gender based on name lists), a semantic reasoning and a machine learning but are not limited to the embodiments mentioned herein) to discover one or more additional information which helps in a entity resolution process. In one embodiment, the entity resolution is process of matching one instance of an entity to another (e.g., matching two customer records together). The outcome of the entity resolution process is a decision that states if the two records are a match (i.e., they are the same), a non-match or a maybe-match.

In one embodiment, the additional information may include a name list, and roles of the entity (e.g., prospect, customer, employee, etc.). The unstructured data may be analyzed using natural language programming (NLP) and/or machine learning classification techniques using missing physical address elements, likes, topics written about, relationship information from profile descriptions. The confidence level identifying module 210 that calculates a confidence level for the additional information. In one embodiment, the confidence level is derived based on at least one of (i) a quality, or (ii) an origin of the associated data. For example, the confidence level may be determined to calculate data quality for an entity A and a second entity B. In one embodiment, the unstructured data and the additional information derived from the unstructured data are validated based on one or more parameters that may include, but are not limited to genuineness and a quality.

The comparison module 212 that compares the additional information with trustworthy information from a database is compared to verify an accuracy of the additional information. The comparison of the one or more entities may be based on a calculation formula. The comparison functions may be the functions that perform the actual comparison of data values and scale the confidence of the comparison with a trust in the data being compared. In one embodiment, the result obtained from the comparison module 212 is an optimal match.

The optimal match includes the data obtained from a comparison between one or more heterogeneous entities. The optimal match may include a comparison of context sensitive elements such as name, location information, relationships, behavior's, transactions, interaction, etc. or like. The matched results (e.g., the data obtained from the optimal match) indicate that the data is authentic. The matched results may be represented such as in a percentage, a graph, a score, etc., in one example embodiment.

The comparison may be between the heterogeneous entity 108A and the heterogeneous entity 108N or between the heterogeneous entities 108A to 108N and an internal database of the user 102. The internal database may be implemented in the computing device 104 associated with the user 102 or an external server such as the entity matching server 110. The best matched result is then sent to the user 102 and displayed as percentage of the matched result. The individual identification module 214 that identifies the individual from the one or more identities and the associated data based on the confidence level.

In one example embodiment, context consideration resolutions include a relationship the entity has with an organization and/or with events. Considering one or more posts (e.g., tweets) as an example in the embodiment herein given they are well known to contain sparse information of unknown quality. The data may include additional information such as location distance from geo-location tagged information, etc., time distance from references tagged in information, tweet text, transactional information from references in tweet text such as purchases, deliveries, returns, etc., interaction information from references in tweet text such as store visits, call center discussions, and likes/interests from topics mentioned in tweet text. This additional information may be used to provide additional data points in the entity resolution process that yields higher confidence in determining if two individuals are the same.

In one embodiment, the data from LinkedIn® is considered more trustworthy than data from Twitter® because LinkedIn® users tend to use their real names instead of aliases, false name, etc. The measure of trust may be calculated by interrogating the data across the various trust dimensions. In one embodiment, matching an internal customer's name that has a high degree of trust to a name from a Twitter® user yields a lower match confidence because Twitter® as a data source has less trust worthy data and the name is not verified as a known name. The entity matching server 110 further include a weight assigning module that assigns a weight for the additional information to derive the confidence level.

The trust measure may be expressed as a weighted-sums formula where each trust dimension is given a weight and the sum of the weights is 100 so the result can be expressed as a percentage. In one example embodiment, the trust measure of a user's location data can be calculated as:

Location trust=70%*Quality Score+30%*provenance Score
Where provenance Score=90% if from LinkedIn®, 70% if from Facebook®, 50% if from Twitter®. Quality Score=100% if City and Province/State are provided and known places, 75% if only City is provided and a known place, 25% if only Province/State is provided and it is a known place, 0% otherwise.

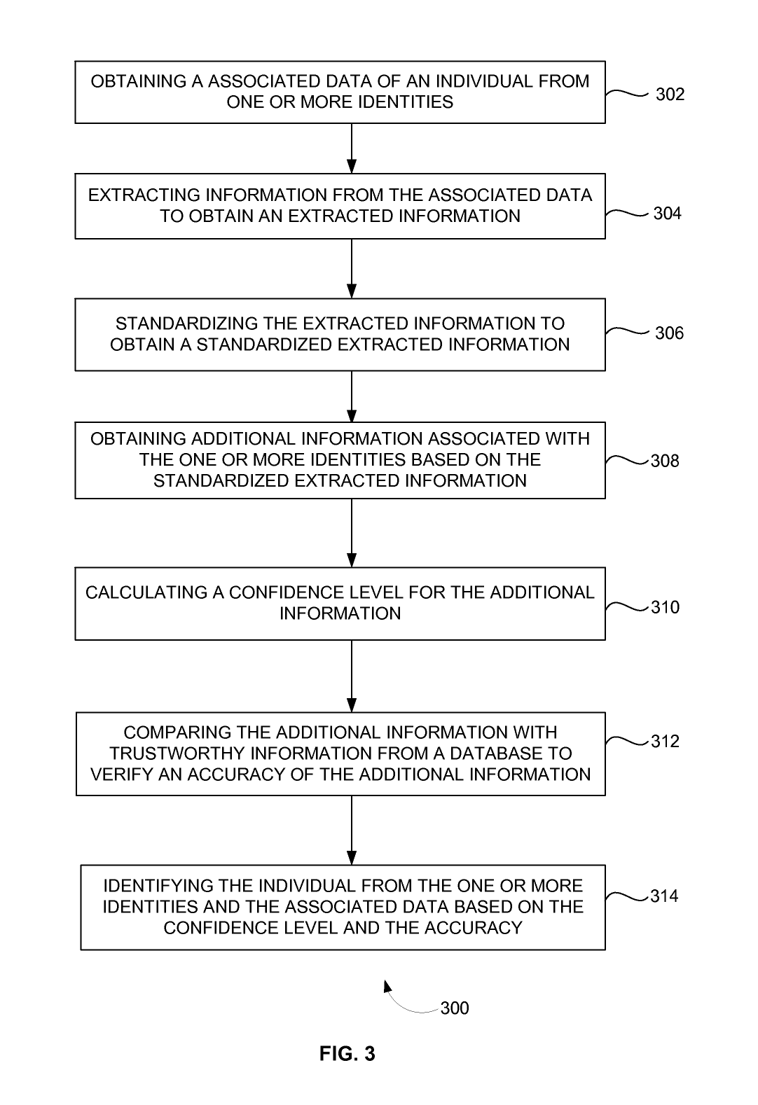

FIG. 3 is a flow diagram illustrating a method of identifying an individual from one or more identities 108A-N and their associated data according to an embodiment herein. In step 302, an associated data of an individual is obtained from one or more identities. In one embodiment, the associated data is unstructured data. In step 304, information is extracted from the associated data to obtain extracted information. In step 306, the extracted information is standardized to obtain standardized extracted information. In step 308, additional information associated with the one or more identities is obtained based on the standardized extracted information. In step 310, a confidence level is calculated for the additional information. The confidence level is derived based on at least one of (i) a quality, or (ii) an origin of the associated data. In step 312, data from a database is compared with the additional information and the one or more identities with the associated data. The data from the database includes trustworthy information. In step 314, the individual is identified from the one or more identities and the associated data based on the confidence level. The associated data include at least one of (i) one or more posts on a social medium, (ii) data associated with an identity on a social medium, (iii) documents, (iv) emails, or (v) web logs.

The standardized extracted information is obtained by at least one of (a) removing one or more noise words from the extracted information, (b) standardizing case associated with the extracted information, or (c) standardizing references associated with the extracted information. The references associated with the information may include (i) a city names, (ii) states/provinces, (iii) units of measures, (iv) one or more terms associated with a name. The extracted information includes at least one of (i) information associated with a name, (ii) information associated with a location, (iii) information associated with a relationship, (iv) other demographic information, or (v) interaction information. The method further includes a weight is assigned for the additional information to derive the confidence level.

In one embodiment, a data quality is calculated for one or more heterogeneous entities. Then, the calculated data quality is validated for one or more heterogeneous entities and one or more heterogeneous entities is compared in the comparison module 212 using following formula:

$$match\_entities ( e 1 , e 2 ) = demographic\_weight * demographic\_match ( e 1 , e 2 ) + relationship\_weight * relationships\_match ( e 1 , e 2 ) + interactions\_weight * interactions\_match ( e 1 , e 2 ) + roles\_weight * roles\_match ( e 1 , e 2 )$$

Where,
demographic_weight+relationships_weight+interactions_weight+roles_weight=100
entity1=e1, entity2=e2
   Within each xxx_match( ) sub-function there are more granular sub-functions. Therefore, the match formula expands out into a hierarchy of sub-functions (i.e., functions nested with functions). For example, demographic match compare many attributes together (examples listed above) to come up with a match confidence. An example is as follows:

$$demographic\_match ( e 1 , e 2 ) = name\_weight * name\_match ( e 1 , e 2 ) + location\_weight * location\_match ( e 1 , e 2 ) + socialprofile\_weight * socialprofile\_match ( e 1 , e 2 ) + … ( , etc ) .$$

The name_match(e1, e2) sub-function has a nested function. An example is as follows:
name_match(e1, e2)=name_comparison_weight*names_to_names_comparison(e1, e2)
+email_comparison_weight*names_to_emails_comparison(e1, e2)
+username_comparison_weight*names_to_usernames_comparison(e1, e2)
+ . . . (, etc).
names_to_names_comparison(e1, e2)=name_comparison(e1.name, e2.name)*
e1.name.trust*e2.name.trust*name_comparison_trust_factor
where, en.name.trust is a trust score as a percentage
0<name_comparison_trust_factor<=1

The compared data from one or more heterogeneous entities is displayed as a matched result in the computing device 104 associated with the user 102. The matched results (e.g., the data obtained from the optimal match) may indicate that the data is authentic. The matched results may be represented such as in percentage, graph, score, etc., in one example embodiment.

In example embodiment, information from a tweets may include transaction information like “Bought a Dishwasher” and “Delivery”, time information like tweet times, and “Delivery on Monday”, location information like Reno WH store in Estero Fla., and interaction information like “Entered store in Estero Fla.”. This additional information may be possible to match the John Smith Twitter® user to an internal customer record with a very high degree of confidence because the probability that two John Smith customers would have purchased a dishwasher on the same day from the same store with delivery on the same day would be less or not possible.

In another example embodiment, the Twitter® user for example, named John Smith and location is Estero, Fla. Now if traditional entity resolution technique is applied it is not possible to match this Twitter® user to an internal customer record with any confidence. The context may give additional data points that can be used to triangulate into an internal customer record. The context may be found in the Twitter® user's tweets like as follows:

Tweet Text: “I'm at Reno WH (Estero, FL)—foursquare.com”

Sent: 2013-01-22 11:30am.

Tweet Text: “Just bought a dishwasher from renowh today. Delivery on Monday!”

Sent: 2013-01-22 5:05pm.

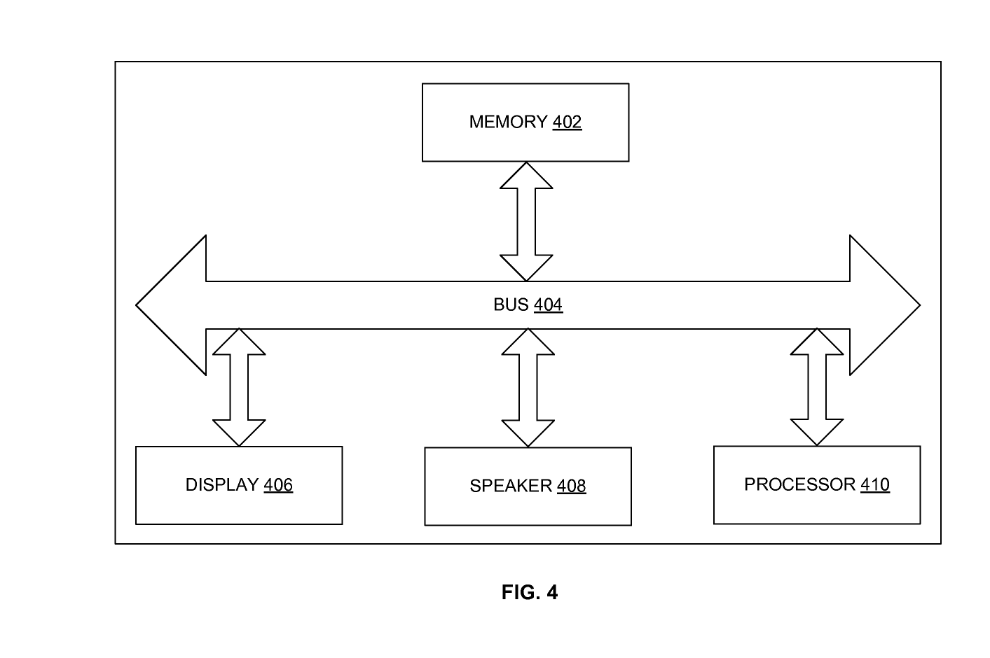

FIG. 4 illustrates an exploded view of the computing device 104 of having an a memory 402 having a set of computer instructions, a bus 404, a display 406, a speaker 408, and a processor 410 capable of processing a set of instructions to perform any one or more of the methodologies herein, according to an embodiment herein. The processor 410 may also enable digital content to be consumed in the form of video for output via one or more displays 406 or audio for output via speaker and/or earphones 408. The processor 410 may also carry out the methods described herein and in accordance with the embodiments herein.

Digital content may also be stored in the memory 402 for future processing or consumption. The memory 402 may also store program specific information and/or service information (PSI/SI), including information about digital content (e.g., the detected information bits) available in the future or stored from the past. A user of the computing device 104 may view this stored information on display 406 and select an item of for viewing, listening, or other uses via input, which may take the form of keypad, scroll, or other input device(s) or combinations thereof. When digital content is selected, the processor 410 may pass information. The content and PSI/SI may be passed among functions within the computing device 104 using the bus 404.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly.

The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections).

In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can take the form of, an entirely hardware embodiment, an entirely software embodiment or an embodiment including both hardware and software elements. The embodiments that are implemented in software include but are not limited to, firmware, resident software, microcode, etc. Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, remote controls, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

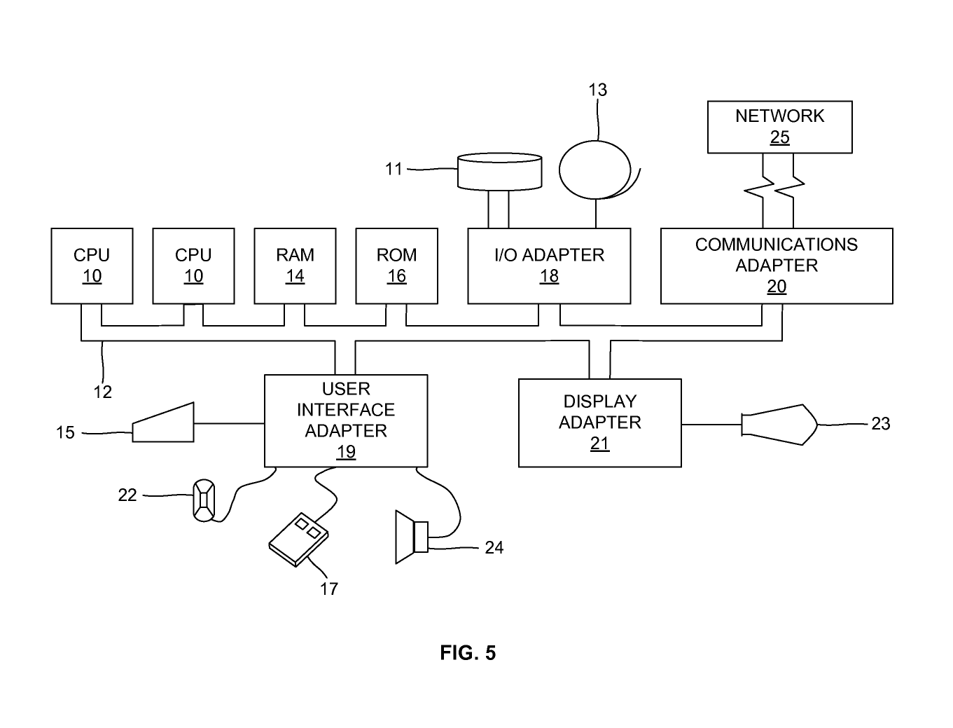

A representative hardware environment for practicing the embodiments herein is depicted in FIG. 5. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein.

The system further includes a user interface adapter 19 that connects a keyboard 15, mouse 17, speaker 24, microphone 22, and/or other user interface devices such as a touch screen device (not shown) or a remote control to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The system enables matching of multiple heterogeneous entities unlike traditional matching techniques such as comparing context sensitive elements such as name, location information, relationships, behavior's, transactions, interaction, etc. or like. The systems have ability to enhance data by extracting information from unstructured text associated with the entity including profile descriptions and one or more posts.

The unstructured data is from entity source like tweets, Facebook® users, emails, documents, web logs, master data management systems, etc., or like. The entity resolution technique may use natural language processing (NLP), semantic reasoning, etc., to extract structured information from semi-structured, unstructured data or like. The structured information from the heterogeneous entities may include name information, location information, relationship information, demographic information (for example email address, birth dates, etc.), and interaction information (for example what is the purchase reference, when was the purchase completed, where was the purchase completed, etc.).

A low quality data with an unknown trust can have serious impacts on the entity resolution process. The solution is to not just apply traditional quality techniques to the data such as putting data in standard form, removing noise words, etc., but also it may measure the quality of the data. This contributes to the measure of trust, confidence, etc., in the data. The quality is one dimension of trust and other dimensions include provenance, which indicates where the data came from and lineage, which indicates how the data presented.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. One or more non-transitory computer readable storage mediums storing one or more sequences of instructions, which when executed by one or more processors, causes
obtaining a associated data of an individual from one or more identities;
extracting information from said associated data to obtain an extracted information;
standardizing said extracted information to obtain a standardized extracted information;
obtaining additional information associated with said one or more identities based on said standardized extracted information;
calculating a confidence level for said additional information, wherein said confidence level is derived based on at least one of (i) a quality, or (ii) an origin of said associated data;
comparing, said additional information with trustworthy information from a database to verify an accuracy of said additional information; and
identifying said individual from said one or more identities and said associated data based on said confidence level and said accuracy.

2. The one or more non-transitory computer readable storage mediums of claim 1, wherein said associated data comprises at least one of (i) one or more posts on a social medium, (ii) data associated with an identity on a social medium, (iii) documents, (iv) emails, or (v) web logs.

3. The one or more non-transitory computer readable storage mediums of claim 1, wherein said standardized extracted information is obtained by at least one of (a) removing one or more noise words from said extracted information, (b) standardizing case associated with said extracted information, or (c) standardizing references associated with said extracted information.

4. The one or more non-transitory computer readable storage mediums of claim 3, wherein said references associated with said information comprise (i) a city names, (ii) states/provinces, (iii) units of measures, (iv) one or more terms associated with a name.

5. The one or more non-transitory computer readable storage mediums of claim 1, wherein said associated data comprises unstructured data.

6. The one or more non-transitory computer readable storage mediums of claim 1, wherein said extracted information comprises at least one of (i) information associated with a name, (ii) information associated with a location, (iii) information associated with a relationship, (iv) other demographic information, or (v) interaction information.

7. The one or more non-transitory computer readable storage mediums of claim 1, further comprising, assigning a weight for said additional information to derive said confidence level.

8. A entity matching server for identifying an individual from one or more identities and associated data, said entity matching server comprising:
(i) a memory unit that stores (a) a set of modules, and (b) a database, wherein said database comprises an associated data and an extracted information, wherein said extracted information comprises at least one of (i) an information associated with a name, (ii) an information associated with a location, (iii) an information associated with a relationship, (iv) other demographic information, or (v) interaction information; and
(ii) a processor which when configured by said instructions executes said set of modules, wherein said set of modules comprises:
(a) an associated data obtaining module, executed by said processor, that obtains associated data associated with said individual from said one or more identities, wherein said associated data comprises unstructured data;
(b) an information extracting module, executed by said processor, that extracts information from said associated data to obtain an extracted information;
(c) an additional information obtaining module, executed by said processor, that obtains additional information associated with said one or more identities based on said extracted information;
(d) a confidence level identifying module, executed by said processor, that calculates a confidence level for said additional information;
(e) a comparison module, executed by said processor, that compares said additional information with trustworthy information from a database to verify an accuracy of said additional information; and
(f) an individual identification module, executed by said processor, that identifies said individual from said one or more identities and said associated data based on said confidence level and said accuracy.

9. The entity matching server of claim 8, wherein said associated data comprises at least one of (i) one or more posts from a social medium, (ii) data associated with an identity on a social medium, (iii) documents, (iv) emails, or (v) web logs.

10. The entity matching server of claim 8, wherein said set of modules further comprises an extracted information standardizing module, executed by said processor, that standardizes said extracted information to obtain a standardized extracted information.

11. The entity matching server of claim 10, wherein said standardized extracted information is obtained by at least one of (i) removing one or more noise words from said information, (ii) standardizing case associated with said extracted information, or (iii) standardizing references associated with said extracted information.

12. The entity matching server of claim 11, wherein said references associated with said information comprises (i) city names, (ii) states/provinces, (iii) units of measures, and (iv) one or more terms associated with a name.

13. The entity matching server of claim 8, wherein said confidence level is derived based on at least one of (i) a quality, or (ii) an origin of said associated data.

14. The entity matching server of claim 8, wherein said set of modules further comprises a weight assigning module, executed by said processor, that assigns a weight for said additional information to derive said confidence level.

15. A processor implemented method of identifying an individual from one or more identities and associated data, said processor implemented method comprising:
obtaining said associated data associated with said individual from said one or more identities, wherein said associated data comprises unstructured data;
extracting information from said associated data to obtain an extracted information, wherein said extracted information comprises at least one of (i) information associated with a name, (ii) information associated with a location, (iii) information associated with a relationship, (iv) other demographic information, or (v) interaction information;
standardizing said extracted information by at least one of (a) removing one or more noise words from said extracted information, (b) standardizing case associated with said extracted information, or (c) standardizing references associated with said extracted information;
obtaining additional information associated with said one or more identities based on said standardized extracted information;
calculating a confidence level for said additional information, wherein said confidence level is derived based on (i) a quality, or (ii) an origin of said associated data;
comparing said additional information with trustworthy information from a database to verify an accuracy of said additional information; and
identifying said individual from said one or more identities and said associated data based on said confidence level and said accuracy.

16. The processor implemented method of claim 15, wherein said associated data comprises at least one of (i) one or more posts on a social medium, (ii) data associated with an identity on a social medium, (iii) emails, or (iv) web logs.

17. The processor implemented method of claim 15, wherein said references associated with said information comprises (i) city names, (ii) states/provinces, (iii) units of measures, (iv) one or more terms associated with a name.

18. The processor implemented method of claim 15, further comprising, assigning a weight for said additional information to derive said confidence level.
